(19) United States
(12) Patent Application Publication
(10) Pub. No.: US 2026/0228788 A1
(43) Pub. Date: Aug. 6, 2026

(54) RANKING BASED ON MACHINE LEARNING

(71) Applicant: Walmart Apollo, LLC, Bentonville, AR (US)

(72) Inventors: Jie Zhao, Rego Park, NY (US); Jungwoo Han, Long Island City, NY (US); Junchao Zheng, Jersey City, NJ (US); Chen Song, Princeton, NJ (US); Rashad M. Eletreby, Cherry Hill, NJ (US); Jun Zhao, Jersey City, NJ (US); Zheng Yan, Short Hills, NJ (US); Daksh Uday Shah, Mountain View, CA (US); Samarth Sharma, Milpitas, CA (US); Vidya Sagar Kalidindi, Milpitas, CA (US); Ramya Magham, San Jose, CA (US); Dip Paresh Shah, Sunnyvale, CA (US); Muneer Syed, Milpitas, CA (US); Keerthana Benachanahalli Suresh, San Ramon, CA (US)

(21) Appl. No.: 19/043,144

(22) Filed: Jan. 31, 2025

(51) Int. Cl. G06Q 30/0601; G06Q 30/0283

(52) U.S. Cl. CPC G06Q 30/0611; G06Q 30/0283

(57) ABSTRACT

Examples related to ranking offers based on machine learning are disclosed. An example may involve: receiving a request for ranking a plurality of offers associated with an item; generating offer related feature data based on the request; inputting the offer related feature data into a machine learning model to generate an order conversion score for each of the plurality of offers; generating, from the plurality of offers, a ranked list of offers based on their respective order conversion scores; and transmitting the ranked list of offers to a computing device.

### BACKGROUND

When multiple options are available, a default option is often selected to be shown to users for convenience. The default option may be selected based on a ranking of the options. For example, an item may be offered by multiple sellers at the same time. A retailer or retail platform may select one of the offers to show as a default offer to a user by ranking the offers.

### BRIEF DESCRIPTION OF THE DRAWINGS

Various examples will be described by the following detailed description of the example embodiments, which is to be considered together with the accompanying drawings wherein like numbers refer to like parts and further wherein:

FIG. 1 is a network environment configured for ranking offers using machine learning, in accordance with some embodiments;

FIG. 2 is a block diagram of a ranked offer computing device, in accordance with some embodiments;

FIG. 3 is a block diagram illustrating various portions of a system for ranking offers using machine learning, in accordance with some embodiments;

FIG. 4 illustrates an example architecture of a system for ranking offers using machine learning, in accordance with some embodiments;

FIG. 5 illustrates an example web page including a default offer for an item, in accordance with some embodiments;

FIG. 6 illustrates an example web page including a ranked list of offers for an item, in accordance with some embodiments;

FIG. 7 shows a flowchart illustrating an example method for ranking offers using machine learning, in accordance with some embodiments;

FIG. 8 shows a flowchart illustrating an example method for ranking eligible offers to generate a ranked list, in accordance with some embodiments;

FIG. 9 shows a flowchart illustrating an example method for determining a default offer, in accordance with some embodiments;

FIG. 10 shows a flowchart illustrating an example method for training a machine learning model for ranking offers, in accordance with some embodiments;

FIG. 11 depicts an example system with a machine-readable medium that includes instructions for ranking offers using machine learning, in accordance with some embodiments.

### DETAILED DESCRIPTION

In some embodiments, systems and methods are described herein for using a machine learning model to rank candidates. The machine learning model can be trained to rank the candidates based on features that are competing to each other.

For example, an item being shown on an item page may have multiple offers for sale from multiple sellers. When a user selects an “add-to-cart” option on the item page, a default offer (e.g. winning offer) of the multiple offers may be added to the cart automatically. The winning offer may be selected or pre-selected from the multiple offers based on a ranking process using a machine learning model.

In some embodiments, during the ranking process, a disclosed system may input offer related feature data into the machine learning model to generate an order conversion score, representing a probability of order conversion from impression, for each offer. Then a ranked list of offers can be generated from the offers based on their respective order conversion scores. While the top ranked offer may be selected from the ranked list as the default offer to show on the item page, a user can also select a “more-sellers” option to view a webpage where all the offers for that item are shown in a ranked order according to the ranked list.

In some embodiments, the offer related feature data may comprise at least: a minimum total price that is a lowest price among all total prices of the offers, a minimum shipping time that is a shortest shipping time among all shipping times of the offers, a difference between a total price of each offer and the minimum total price, and a difference between a shipping time of each offer and the minimum shipping time. The machine learning model may be trained to capture an intricate trade-off between competing features, e.g. the offer price and the shipping speed, based on historical user interaction data. In some embodiments, the machine learning model can be trained to optimize an objective function subject to a monotonic constraint. The monotonic constraint may require a monotonic relationship from each feature to the output order conversion scores, while keeping other features unchanged.

In some examples, the default offer may be used in a buy box section in different types of webpages comprising: e.g. a home page, an item page, a search page, a browse page, a list of personalized carousels, a list of user selected items, a list of user related items, a list of sponsored advertisements, etc.

In some embodiments, the system may utilize a machine learning model that learns the ranking adaptively without a need of manually setting up rules. By imposing monotonic constraints on price and shipping related signals during model training, the system can generate ranking results that are more intuitive to users, while maintaining an intricate tradeoff between price and shipping. The utilized machine learning model can reduce a seller's motivation to manipulate the offer, and increase the seller's motivation to improve service quality in terms of price, shipping, etc.

In various embodiments, a system including a processor and a non-transitory memory storing instructions is disclosed. The instructions, when executed, cause the processor to: receive a request for ranking a plurality of offers associated with an item; generate offer related feature data based on the request; input the offer related feature data into a machine learning model to generate an order conversion score for each of the plurality of offers; generate, from the plurality of offers, a ranked list of offers based on their respective order conversion scores; and transmit the ranked list of offers to a computing device.

In various embodiments, a computer-implemented method is disclosed. The computer-implemented method includes: receiving a request for ranking a plurality of offers associated with an item; generating offer related feature data based on the request; inputting the offer related feature data into a machine learning model to generate an order conversion score for each of the plurality of offers; generating, from the plurality of offers, a ranked list of offers based on their respective order conversion scores; and transmitting the ranked list of offers to a computing device.

In various embodiments, a non-transitory computer readable medium having instructions stored thereon is disclosed. The instructions, when executed by at least one processor, cause at least one device to perform operations including: receiving a request for ranking a plurality of offers associated with an item; generating offer related feature data based on the request; inputting the offer related feature data into a machine learning model to generate an order conversion score for each of the plurality of offers; generating, from the plurality of offers, a ranked list of offers based on their respective order conversion scores; and transmitting the ranked list of offers to a computing device.

This description of the example embodiments is intended to be read in connection with the accompanying drawings, which are to be considered part of the entire written description. Terms concerning data connections, coupling and the like, such as “connected” and “interconnected,” and/or “in signal communication with” refer to a relationship wherein systems or elements are electrically and/or wirelessly connected to one another either directly or indirectly through intervening systems, as well as both moveable or rigid attachments or relationships, unless expressly described otherwise. The term “operatively coupled” is such a coupling or connection that enables the pertinent structures to operate as intended by virtue of that relationship.

In the following, various embodiments are described with respect to the claimed systems as well as with respect to the claimed methods. Features, advantages or alternative embodiments herein can be assigned to the other claimed objects and vice versa. In other words, claims for the systems can be improved with features described or claimed in the context of the methods. In this case, the functional features of the method are embodied by objective units of the systems.

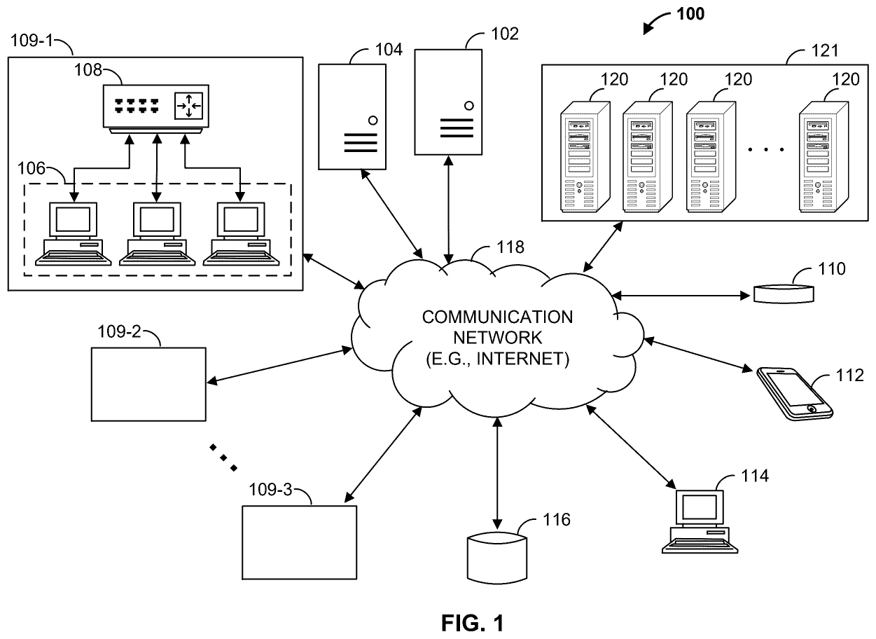

Turning to the drawings, FIG. 1 is a network environment 100 configured for ranking offers using machine learning, in accordance with some embodiments. The network environment 100 includes a plurality of devices or systems that can communicate over one or more network channels, illustrated as a network cloud 118. For example, in various embodiments, the network environment 100 can include, but not limited to, a ranked offer computing device 102, a server 104 (e.g., a web server or an application server), a cloud-based engine 121 including one or more processing devices 120, workstation(s) 106, a database 116, and one or more user computing devices 110, 112, 114 operatively coupled over the network 118. The ranked offer computing device 102, the server 104, the workstation(s) 106, the processing device(s) 120, and the multiple user computing devices 110, 112, 114 can each be any suitable computing device that includes any hardware or hardware and software combination for processing and handling information. For example, each can include one or more processors, one or more field-programmable gate arrays (FPGAs), one or more application-specific integrated circuits (ASICs), one or more state machines, digital circuitry, or any other suitable circuitry. In addition, each can transmit and receive data over the communication network 118.

In some examples, each of the ranked offer computing device 102 and the processing device(s) 120 can be a computer, a workstation, a laptop, a server such as a cloud-based server, or any other suitable device. In some examples, each of the processing devices 120 is a server that includes one or more processing units, such as one or more graphical processing units (GPUs), one or more Tensor Processing Units (TPUs), one or more central processing units (CPUs), and/or one or more processing cores. Each processing device 120 may, in some examples, execute one or more virtual machines. In some examples, processing resources (e.g., capabilities) of the one or more processing devices 120 are offered as a cloud-based service (e.g., cloud computing). For example, the cloud-based engine 121 may offer computing and storage resources of the one or more processing devices 120 to the ranked offer computing device 102.

In some examples, each of the multiple user computing devices 110, 112, 114 can be a cellular phone, a smart phone, a tablet, a personal assistant device, a voice assistant device, a digital assistant, a laptop, a computer, a laser-based code scanner, or any other suitable device. In some examples, the server 104 hosts one or more websites or apps providing one or more products or services. In some examples, the ranked offer computing device 102, the processing devices 120, and/or the server 104 are operated by a corporation, e.g. a big retailer, and the multiple user computing devices 110, 112, 114 are operated by customers, advertisers, associates or managers of the corporation. In some examples, the processing devices 120 are operated by a third party (e.g., a cloud-computing provider).

The workstation(s) 106 are operably coupled to the communication network 118 via a router (or switch) 108. The workstation(s) 106 and/or the router 108 may be located at a fulfillment node 109-1 of a retailer, for example. The fulfillment node 109-1 may be a store, a warehouse, a fulfillment center or a distribution center of the retailer. At the same time, the retailer may also include other fulfillment nodes 109-2, 109-3, each of which is also associated with one or more workstation(s) similarly to the fulfillment node 109-1. The fulfillment nodes 109-1, 109-2, 109-3 will be together referred to as fulfillment nodes 109 (or nodes 109).

The workstation(s) 106 can communicate with the ranked offer computing device 102 over the communication network 118. The workstation(s) 106 may send data to, and receive data from, the ranked offer computing device 102. For example, the workstation(s) 106 may transmit data identifying transactions, inventory, assortment, supply chain data and/or waste data at the one or more fulfillment nodes 109 to the ranked offer computing device 102. The workstation(s) 106 may also transmit other data related to the one or more fulfillment nodes 109 to the ranked offer computing device 102.

Although FIG. 1 illustrates three user computing devices 110, 112, 114, the network environment 100 can include any number of user computing devices 110, 112, 114. Similarly, the network environment 100 can include any number of the ranked offer computing devices 102, the processing devices 120, the workstations 106, the fulfillment nodes 109, the servers 104, and the databases 116.

The communication network 118 can be a WiFi® network, a cellular network such as a 3GPP® network, a Bluetooth® network, a satellite network, a wireless local area network (LAN), a network utilizing radio-frequency (RF) communication protocols, a Near Field Communication (NFC) network, a wireless Metropolitan Area Network (MAN) connecting multiple wireless LANs, a wide area network (WAN), or any other suitable network. The communication network 118 can provide access to, for example, the Internet.

In some embodiments, each of the first user computing device 110, the second user computing device 112, and the Nth user computing device 114 may communicate with the server 104 over the communication network 118. For example, one of the multiple user computing devices 110, 112, 114 may be operable to view, access, and interact with a website, such as a retailer's website, hosted by the server 104. The server 104 may capture user session data related to a customer's activity (e.g., interactions) on the website. For example, a customer may operate one of the user computing devices 110, 112, 114 to initiate a web browser that is directed to the website hosted by the server 104. The customer may, via the web browser, search for items, view item advertisements for items displayed on the website, and click on item advertisements and/or items in the search result, for example. The website may capture these activities as user session data, and transmit the user session data to the ranked offer computing device 102 over the communication network 118. The website may also enable the customer to add one or more of the items to an online shopping cart, and enable the customer to perform a “checkout” of the shopping cart to purchase the items. In some examples, the server 104 transmits purchase data identifying items the customer has purchased from the website to the ranked offer computing device 102.

In some examples, the server 104 transmits an offer ranking request to the ranked offer computing device 102 for ranking a plurality of offers associated with an item. In some examples, the offer ranking request may be triggered by a new offer added for the item. In some examples, the offer ranking request may be triggered by an update of an offer for the item.

The ranked offer computing device 102 may generate offer related feature data based on the offer ranking request. Then, the ranked offer computing device 102 can input the offer related feature data into a machine learning model to generate an order conversion score for each of the plurality of offers. From the plurality of offers, the ranked offer computing device 102 can generate a ranked list of offers based on their respective order conversion scores. The ranked list of offers may be transmitted to the server 104.

In some embodiments, the ranked offer computing device 102 or the server 104 can select a top ranked offer from the ranked list of offers, and determine the top ranked offer as a default offer to be displayed together with the item in a web page.

In some examples, a user selects an item on a website hosted by the server 104, e.g. by clicking on the item, to view its product description details. The server 104 may direct the user to an item page showing the product description details of item, together with the default offer. When the user selects an “add-to-cart” or “buy-now” option, the default offer will be automatically used for the user to purchase the item. The user may also choose a “more-seller” option to view more offer options in a ranked list as generated above.

In some examples, a user submits a search query on a website hosted by the server 104, e.g. by entering a query in a search bar. The server 104 may direct the user to a search page showing the search results for the query. Each item in the search results may be displayed together with a corresponding default offer. When the user selects an “add-to-cart” or “buy-now” option for one item on the search page, the corresponding default offer will be automatically used for the user to purchase the item.

In some embodiments, the ranked offer computing device 102 is further operable to communicate with the database 116 over the communication network 118. For example, the ranked offer computing device 102 can store data to, and read data from, the database 116. The database 116 can be a remote storage device, such as a cloud-based server, a disk (e.g., a hard disk), a memory device on another application server, a networked computer, or any other suitable remote storage. Although shown remote to the ranked offer computing device 102, in some examples, the database 116 can be a local storage device, such as a hard drive, a non-volatile memory, or a USB stick. For example, the ranked offer computing device 102 may store online purchase data received from the server 104 in the database 116. The ranked offer computing device 102 may receive in-store purchase data and node related data from different fulfillment nodes 109 and store them in the database 116. The ranked offer computing device 102 may also receive from the server 104 user session data identifying events associated with browsing sessions, and may store the user session data in the database 116. The ranked offer computing device 102 may also compute order conversion scores to generate a ranked offer list in response to an offer ranking request received from the server 104 (or the fulfillment nodes 109), and may store the ranked offer list in the database 116.

In some examples, the ranked offer computing device 102 generates and/or updates different models (e.g., machine learning models, deep learning models, statistical models, algorithms, natural language models, etc.) for ranking offers using machine learning. The ranked offer computing device 102 may generate training data for the models based on data including but not limited to: item features, offer related features, historical order conversion data, and historical feedback data. The ranked offer computing device 102 trains the models based on their corresponding training data, and stores the models in a database, such as in the database 116 (e.g., a cloud storage). The models, when executed by the ranked offer computing device 102, may enable the ranked offer computing device 102 to generate a ranked list of offers for an item.

In some examples, the ranked offer computing device 102 assigns the models (or parts thereof) for execution to one or more processing devices 120. For example, each model may be assigned to a virtual machine hosted by a processing device 120. The virtual machine may cause the models or parts thereof to execute on one or more processing units such as GPUs. In some examples, the virtual machines assign each model (or part thereof) among a plurality of processing units. Based on the output of the models, the ranked offer computing device 102 may generate a ranked list of offers for an item.

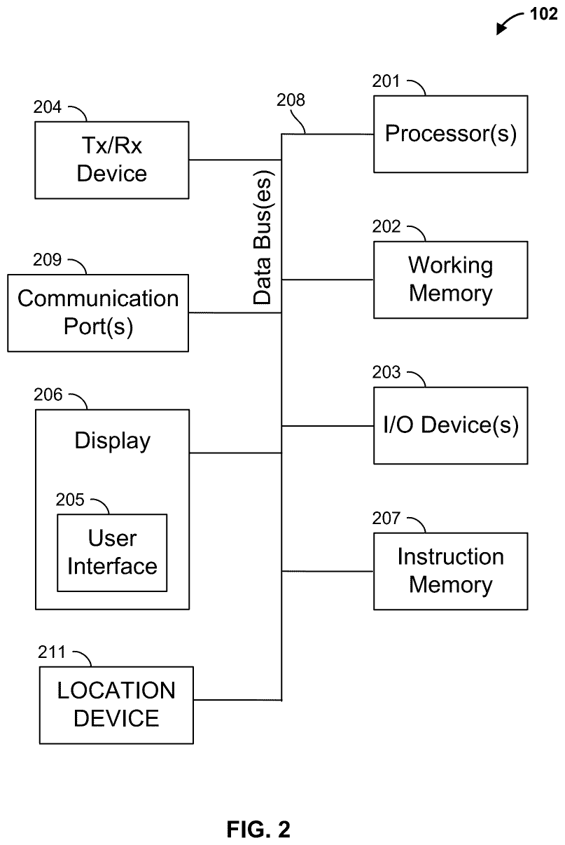

FIG. 2 illustrates a block diagram of a ranked offer computing device, e.g. the ranked offer computing device 102 of FIG. 1, in accordance with some embodiments. In some embodiments, each of the ranked offer computing device 102, the server 104, the workstation(s) 106, the multiple user computing devices 110, 112, 114, and the one or more processing devices 120 in FIG. 1 may include the features shown in FIG. 2. Although FIG. 2 is described with respect to certain components shown therein, it will be appreciated that the elements of the ranked offer computing device 102 can be combined, omitted, and/or replicated. In addition, it will be appreciated that additional elements other than those illustrated in FIG. 2 can be added to the ranked offer computing device 102.

As shown in FIG. 2, the ranked offer computing device 102 can include one or more processors 201, an instruction memory 207, a working memory 202, one or more input/output devices 203, one or more communication ports 209, a transceiver 204, a display 206 with a user interface 205, and an optional location device 211, all operatively coupled to one or more data buses 208. The data buses 208 enable communication among the various components. The data buses 208 can include wired, or wireless, communication channels.

The one or more processors 201 can include any processing circuitry operable to control operations of the ranked offer computing device 102. In some embodiments, the one or more processors 201 include one or more distinct processors, each having one or more cores (e.g., processing circuits). Each of the distinct processors can have the same or different structure. The one or more processors 201 can include one or more central processing units (CPUs), one or more graphics processing units (GPUs), application specific integrated circuits (ASICs), digital signal processors (DSPs), a chip multiprocessor (CMP), a network processor, an input/output (I/O) processor, a media access control (MAC) processor, a radio baseband processor, a co-processor, a microprocessor such as a complex instruction set computer (CISC) microprocessor, a reduced instruction set computing (RISC) microprocessor, and/or a very long instruction word (VLIW) microprocessor, or other processing device. The one or more processors 201 may also be implemented by a controller, a microcontroller, an application specific integrated circuit (ASIC), a field programmable gate array (FPGA), a programmable logic device (PLD), etc.

In some embodiments, the one or more processors 201 can implement an operating system (OS) and/or various applications. Examples of an OS include, for example, operating systems generally known under various trade names such as Apple macOS™, Microsoft Windows™, Android™, Linux™, and/or any other proprietary or open-source OS. Examples of applications include, for example, network applications, local applications, data input/output applications, user interaction applications, etc.

The instruction memory 207 can store instructions that can be accessed (e.g., read) and executed by at least one of the one or more processors 201. For example, the instruction memory 207 can be a non-transitory, computer-readable storage medium such as a read-only memory (ROM), an electrically erasable programmable read-only memory (EEPROM), flash memory (e.g. NOR and/or NAND flash memory), content addressable memory (CAM), polymer memory (e.g., ferroelectric polymer memory), phase-change memory (e.g., ovonic memory), ferroelectric memory, silicon-oxide-nitride-oxide-silicon (SONOS) memory, a removable disk, CD-ROM, any non-volatile memory, or any other suitable memory. The one or more processors 201 can perform a certain function or operation by executing code, stored on the instruction memory 207, embodying the function or operation. For example, the one or more processors 201 can execute code stored in the instruction memory 207 to perform one or more of any function, method, or operation disclosed herein.

Additionally, the one or more processors 201 can store data to, and read data from, the working memory 202. For example, the one or more processors 201 can store a working set of instructions to the working memory 202, such as instructions loaded from the instruction memory 207. The one or more processors 201 can also use the working memory 202 to store dynamic data created during one or more operations. The working memory 202 can include, for example, random access memory (RAM) such as a static random access memory (SRAM) or dynamic random access memory (DRAM), Double-Data-Rate DRAM (DDR-RAM), synchronous DRAM (SDRAM), an EEPROM, flash memory (e.g. NOR and/or NAND flash memory), content addressable memory (CAM), polymer memory (e.g., ferroelectric polymer memory), phase-change memory (e.g., ovonic memory), ferroelectric memory, silicon-oxide-nitride-oxide-silicon (SONOS) memory, a removable disk, CD-ROM, any non-volatile memory, or any other suitable memory. Although embodiments are illustrated herein including separate instruction memory 207 and working memory 202, it will be appreciated that the ranked offer computing device 102 can include a single memory unit to operate as both instruction memory and working memory. Further, although embodiments are discussed herein including non-volatile memory, it will be appreciated that the ranked offer computing device 102 can include volatile memory components in addition to at least one non-volatile memory component.

In some embodiments, the instruction memory 207 and/or the working memory 202 includes an instruction set, in the form of a file for executing various methods, e.g. any method as described herein. The instruction set can be stored in any acceptable form of machine-readable instructions, including source code or various appropriate programming languages. Some examples of programming languages that can be used to store the instruction set include, but are not limited to: Java, JavaScript, C, C++, C#, Python, Objective-C, Visual Basic, .NET, HTML, CSS, SQL, NoSQL, Rust, Perl, etc. In some embodiments, a compiler or interpreter can convert the instruction set into machine executable code for execution by the one or more processors 201.

The input-output devices 203 can include any suitable device that enables data input or output. For example, the input-output devices 203 can include one or more of a keyboard, a touchpad, a mouse, a stylus, a touchscreen, a physical button, a speaker, a microphone, a keypad, a click wheel, a motion sensor, a camera, and/or any other suitable input or output device.

The transceiver 204 and/or the communication port(s) 209 enable communication with a network, such as the communication network 118 of FIG. 1. For example, if the communication network 118 of FIG. 1 is a cellular network, the transceiver 204 enables communications with the cellular network. In some embodiments, the transceiver 204 is selected based on the type of the communication network 118 the ranked offer computing device 102 will be operating in. The one or more processors 201 are operable to receive data from, or send data to, a network, such as the communication network 118 of FIG. 1, via the transceiver 204.

The communication port(s) 209 may include any suitable hardware, software, and/or combination of hardware and software that is capable of coupling the ranked offer computing device 102 to one or more networks and/or additional devices. The communication port(s) 209 can be arranged to operate with any suitable technique for controlling information signals using a desired set of communications protocols, services, or operating procedures. The communication port(s) 209 can include the appropriate physical connectors to connect with a corresponding communications medium, whether wired or wireless, for example, a serial port such as a universal asynchronous receiver/transmitter (UART) connection, a Universal Serial Bus (USB) connection, or any other suitable communication port or connection. In some embodiments, the communication port(s) 209 enables the programming of executable instructions in the instruction memory 207. In some embodiments, the communication port(s) 209 enables the transfer (e.g., uploading or downloading) of data, such as machine learning model training data.

In some embodiments, the communication port(s) 209 may couple the ranked offer computing device 102 to a network. The network can include local area networks (LAN) as well as wide area networks (WAN) including without limitation Internet, wired channels, wireless channels, communication devices including telephones, computers, wire, radio, optical and/or other electromagnetic channels, and combinations thereof, including other devices and/or components capable of/associated with communicating data. For example, the communication environments can include in-body communications, various devices, and various modes of communications such as wireless communications, wired communications, and combinations of the same.

In some embodiments, the transceiver 204 and/or the communication port(s) 209 can utilize one or more communication protocols. Examples of wired protocols can include, but are not limited to, Universal Serial Bus (USB) communication, RS-232, RS-422, RS-423, RS-485 serial protocols, FireWire, Ethernet, Fibre Channel, MIDI, ATA, Serial ATA, PCI Express, T-1 (and variants), Industry Standard Architecture (ISA) parallel communication, Small Computer System Interface (SCSI) communication, or Peripheral Component Interconnect (PCI) communication, etc. Examples of wireless protocols can include, but are not limited to, the Institute of Electrical and Electronics Engineers (IEEE) 802.xx series of protocols, such as IEEE 802.11a/b/g/n/ac/ag/ax/be, IEEE 802.16, IEEE 802.20, GSM cellular radiotelephone system protocols with GPRS, CDMA cellular radiotelephone communication systems with 1xRTT, EDGE systems, EV-DO systems, EV-DV systems, HSDPA systems, Wi-Fi Legacy, Wi-Fi 1/2/3/4/5/6/6E, wireless personal area network (PAN) protocols, Bluetooth Specification versions 5.0, 6, 7, legacy Bluetooth protocols, passive or active radio-frequency identification (RFID) protocols, Ultra-Wide Band (UWB), Digital Office (DO), Digital Home, Trusted Platform Module (TPM), ZigBee, etc.

The display 206 can be any suitable display, and may display the user interface 205. For example, the user interfaces 205 can enable user interaction with the ranked offer computing device 102 and/or the server 104. For example, the user interface 205 can be a user interface for an application of a network environment operator that enables a customer to view and interact with the operator's website. In some embodiments, a user can interact with the user interface 205 by engaging the input-output devices 203. In some embodiments, the display 206 can be a touchscreen, where the user interface 205 is displayed on the touchscreen.

The display 206 can include a screen such as, for example, a Liquid Crystal Display (LCD) screen, a light-emitting diode (LED) screen, an organic LED (OLED) screen, a movable display, a projection, etc. In some embodiments, the display 206 can include a coder/decoder, also known as Codecs, to convert digital media data into analog signals. For example, the visual peripheral output device can include video Codecs, audio Codecs, or any other suitable type of Codec.

The optional location device 211 may be communicatively coupled to a location network and operable to receive position data from the location network. For example, in some embodiments, the location device 211 includes a GPS device that receives position data identifying a latitude and longitude from one or more satellites of a GPS constellation. As another example, in some embodiments, the location device 211 is a cellular device that receives location data from one or more localized cellular towers. Based on the position data, the ranked offer computing device 102 may determine a local geographical area (e.g., town, city, state, etc.) of its position.

In some embodiments, the ranked offer computing device 102 can implement one or more modules or engines, each of which is constructed, programmed, configured, or otherwise adapted, to autonomously carry out a function or set of functions. A module/engine can include a component or arrangement of components implemented using hardware, such as by an application specific integrated circuit (ASIC) or field-programmable gate array (FPGA), for example, or as a combination of hardware and software, such as by a microprocessor system and a set of program instructions that adapt the module/engine to implement the particular functionality, which (while being executed) transform the microprocessor system into a special-purpose device. A module/engine can also be implemented as a combination of the two, with certain functions facilitated by hardware alone, and other functions facilitated by a combination of hardware and software. In certain implementations, at least a portion, and in some cases, all, of a module/engine can be executed on the processor(s) of one or more computing platforms that are made up of hardware (e.g., one or more processors, data storage devices such as memory or drive storage, input/output facilities such as network interface devices, video devices, keyboard, mouse or touchscreen devices, etc.) that execute an operating system, system programs, and application programs, while also implementing the engine using multitasking, multithreading, distributed (e.g., cluster, peer-peer, cloud, etc.) processing where appropriate, or other such techniques. Accordingly, each module/engine can be realized in a variety of physically realizable configurations, and should generally not be limited to any particular implementation exemplified herein, unless such limitations are expressly called out. In addition, a module/engine can itself be composed of more than one sub-modules or sub-engines, each of which can be regarded as a module/engine in its own right. Moreover, in the embodiments described herein, each of the various modules/engines corresponds to a defined autonomous functionality; however, it should be understood that in other contemplated embodiments, each functionality can be distributed to more than one module/engine. Likewise, in other contemplated embodiments, multiple defined functionalities may be implemented by a single module/engine that performs those multiple functions, possibly alongside other functions, or distributed differently among a set of modules/engines than specifically illustrated in the embodiments herein.

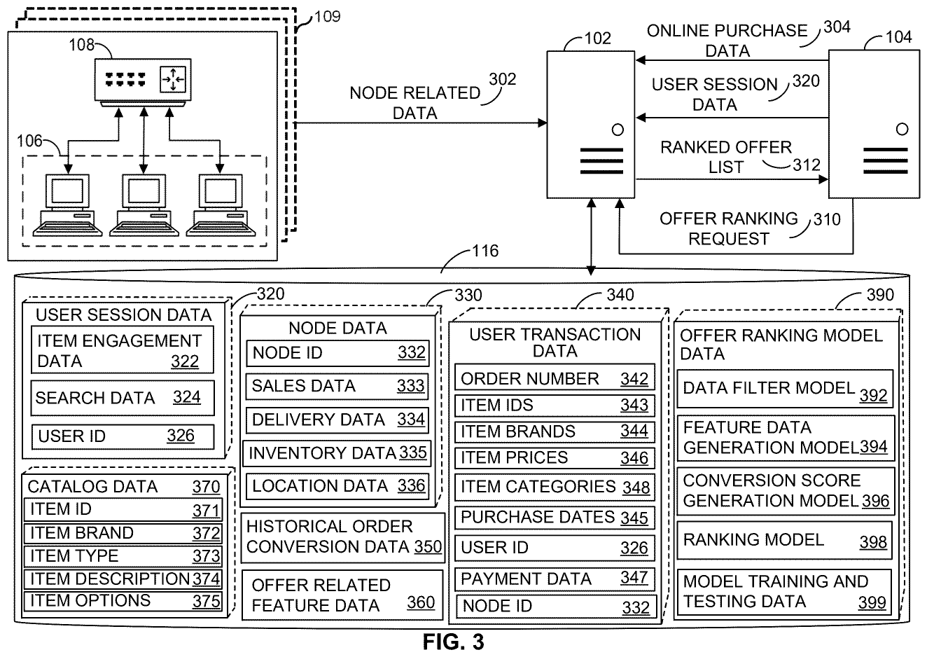

FIG. 3 is a block diagram illustrating various portions of a system for ranking offers using machine learning, e.g. the system shown in the network environment 100 of FIG. 1, in accordance with some embodiments. As indicated in FIG. 3, the ranked offer computing device 102 may receive user session data 320 from the server 104, and store the user session data 320 in the database 116. The user session data 320 may identify, for each user (e.g., customer, seller, associate), data related to that user's browsing session, such as when browsing a retailer's webpage hosted by the server 104. In some embodiments, the system may not utilize all of the components and data shown in FIG. 3 for recommending and optimizing inventory target levels for items.

In some examples, the user session data 320 may include item engagement data 322, search data 324, and user ID 326 (e.g., a customer ID, seller ID, associate ID, retailer website login ID, a cookie ID, etc.). The item engagement data 322 may include one or more of a session ID (i.e., a website browsing session identifier), item clicks identifying items which a user clicked (e.g., images of items for purchase, keywords to filter reviews for an item), items viewed by the user, items added-to-cart identifying items added to the user's online shopping cart, advertisements viewed identifying advertisements the user viewed during the browsing session, and advertisements clicked identifying advertisements the user clicked on. The search data 324 may identify one or more searches conducted by a user during a browsing session (e.g., a current browsing session).

The ranked offer computing device 102 may also receive online purchase data 304 from the server 104, which identifies and characterizes one or more online purchases, such as purchases made by the user and other users via a retailer's website hosted by the server 104. The ranked offer computing device 102 may also receive node related data 302 from the fulfillment nodes 109, which identifies and characterizes one or more in-store purchases, product location data, inventory data, and/or assortment data related to each of the fulfillment nodes 109. In some embodiments, the node related data 302 may also indicate other information about the fulfillment nodes 109. In some embodiments, the fulfillment nodes 109 and the server 104 are associated with each other such that the online purchase data 304, the user session data 320 and the node related data 302 all come from a same server cluster or datacenter.

The ranked offer computing device 102 may parse the node related data 302 and the online purchase data 304 to generate user transaction data 340. In this example, the user transaction data 340 may include, for each purchase, one or more of: an order number 342 identifying a purchase order, item IDs 343 identifying one or more items purchased in the purchase order, item brands 344 identifying a brand for each item purchased, item prices 346 identifying the price of each item purchased, item categories 348 identifying a product type (or category) of each item purchased, purchase dates 345 identifying the purchase dates of the purchase orders, a user ID 326 for the user making the corresponding purchase, payment data 347 indicating payment methods and related information (e.g. emails associated with payment) for corresponding orders, and node ID 332 for the corresponding in-store purchase, or for the pickup store or shipping-from store associated with the corresponding online purchase.

In some embodiments, the database 116 may further store catalog data 370, which may identify one or more attributes of a plurality of items, such as a portion of or all items a retailer carries in stores and/or at e-commerce platforms. The catalog data 370 may identify, for each of the plurality of items, an item ID 371 (e.g., an SKU number), item brand 372, item type 373 (e.g., grocery item such as milk, clothing item), item description 374 (e.g., a description of the product including product features, such as ingredients, benefits, use or consumption instructions, or any other suitable description), and item options 375 (e.g., item colors, sizes, flavors, etc.).

In some examples, the ranked offer computing device 102 receives an offer ranking request 310 for ranking a plurality of offers associated with an item. The item may be offered for sale on a website hosted by the server 104. In some examples, the offer ranking request 310 may be triggered by a newly added offer for the item, an updated offer for the item, or a new item offered for sale. The ranked offer computing device 102 may generate offer related feature data based on the offer ranking request 310, and input the offer related feature data into a machine learning model to generate an order conversion score for each of the plurality of offers. Then from the plurality of offers, the ranked offer computing device 102 can generate a ranked offer list 312 of the offers based on their respective order conversion scores, and transmit the ranked offer list 312 to the server 104.

In some embodiments, a top ranked offer is selected as a default offer from the ranked offer list 312, and is displayed together with the item in a web page to a user. For example, the web page may be any one of: a home page; an item page; a search result page; a browse page; or a web page including a list of personalized carousels, a list of user selected items, a list of user related items, or a list of sponsored advertisements. In some examples, upon a first selection of the user on the web page, the default offer for the item is added into a shopping cart for the user. In some examples, upon a second selection of the user on the web page, the user is re-directed to an additional web page where all offers in the ranked offer list 312 are displayed in a ranked order.

In some embodiments, the ranked offer computing device 102 may generate node data 330 based on the node related data 302. In some examples, the node data 330 may include, for each node, one or more of: the node ID 332 of the node, sales data 333 indicating data of historical sales for each item in the node, delivery data 334 indicating data of historical deliveries of each item to and from the node, inventory data 335 identifying and charactering an inventory status for each item in the node, and location data 336 identifying a location of the node.

In some examples, the database 116 may also store historical order conversion data 350 identifying historical orders converted from impressions. In some examples, the database 116 may also store offer related feature data 360 identifying features related to offers, e.g. price, shipping speed, etc.

The database 116 may also store offer ranking model data 390 identifying and characterizing one or more models and related data for ranking offers using machine learning. For example, the offer ranking model data 390 may include: a data filter model 392, a feature data generation model 394, a conversion score generation model 396, a ranking model 398 and model training and testing data 399. In various embodiments, the offer ranking model data 390 includes any number of the data filter models 392, the feature data generation models 394, the conversion score generation models 396, and the ranking models 398.

The data filter model 392 in some examples can be used to filter the plurality of offers to remove ineligible offers and generate a list of eligible offers. In some examples, the data filter model 392 can be used to remove each offer with an out-of-stock status of the item. In some examples, the data filter model 392 can also be used to remove each offer with a violation of a rule associated with the item, e.g. an offer linking to an external website, an offer cross-promoting another item, an offer bundling the item with another item, an offer selling an old item as a new item, etc.

The feature data generation model 394 may be used to generate offer related feature data based on the offer ranking request 310. In some examples, the offer related feature data may comprise at least: a minimum total price that is a lowest price among all total prices of the plurality of offers; a minimum shipping time that is a shortest shipping time among all shipping times of the plurality of offers; a difference between a total price of each offer and the minimum total price; and a difference between a shipping time of each offer and the minimum shipping time. In some examples, the system may use the feature data generation model 394 to generate the feature data related to the eligible offers identified by the data filter model 392.

The conversion score generation model 396 in some examples may be used to generate an order conversion score for each of the plurality of offers based on the offer related feature data generated by the feature data generation model 394. In some examples, the order conversion score for an offer may indicate a probability of converting the offer to a purchase order. In some examples, the system may use the conversion score generation model 396 to merely generate an order conversion score for each of the eligible offers identified by the data filter model 392.

In some examples, the conversion score generation model 396 may be a machine learning model trained using a training dataset to output order conversion scores that can optimize an objective function subject to a monotonic constraint. The training dataset may be generated based on: feature data of default offers for a plurality of items, and label data generated based on orders placed regarding the default offers for the plurality of items, e.g. via item pages. In some examples, the objective function is a point-wise loss for predicting a conversion probability of each individual offer. The monotonic constraint may require a monotonic relationship from each feature in the feature data to the output order conversion scores, given other features unchanged in the feature data.

The ranking model 398 in this example can be used to generate a ranked offer list 312 of offers based on their respective order conversion scores generated by the conversion score generation model 396. The offers being ranked may be the plurality of offers associated with the offer ranking request 310, or merely the eligible offers identified by the data filter model 392.

In some embodiments, the ranked offer computing device 102 can transmit the ranked offer list 312 to the server 104. In some embodiments, the ranked offer list 312 is transmitted together with the order conversion score for each offer in the ranked offer list 312. In some embodiments, the ranked offer computing device 102 or the server 104 may select a top ranked offer from the ranked offer list 312 as a default offer to be displayed together with the item in a web page, e.g. a home page, an item page, a search result page, etc. A user can view the full list of the ranked offer list 312 by selecting an option (e.g. a “more-seller” option) on the web page.

In some embodiments, one or more of the data filter model 392, the feature data generation model 394, the conversion score generation model 396 and the ranking model 398 can be implemented as a machine learning model, a natural language model, or a large language model. The model training and testing data 399 may include data utilized for training one or more of the data filter model 392, the feature data generation model 394, the conversion score generation model 396 and the ranking model 398. In some examples, the model training and testing data 399 may be formed based on: item features, user features, offer related features, historical or labelled order conversion data, historical or labelled ranking data, and historical feedback data, obtained from either real data or synthetic data.

In some embodiments, the ranked offer computing device 102 may assign one or more of the above described operations to a different processing unit or virtual machine hosted by one or more processing devices 120. Further, the ranked offer computing device 102 may obtain the outputs of these assigned operations from the processing units, and generate the ranked offer list 312 based on the outputs.

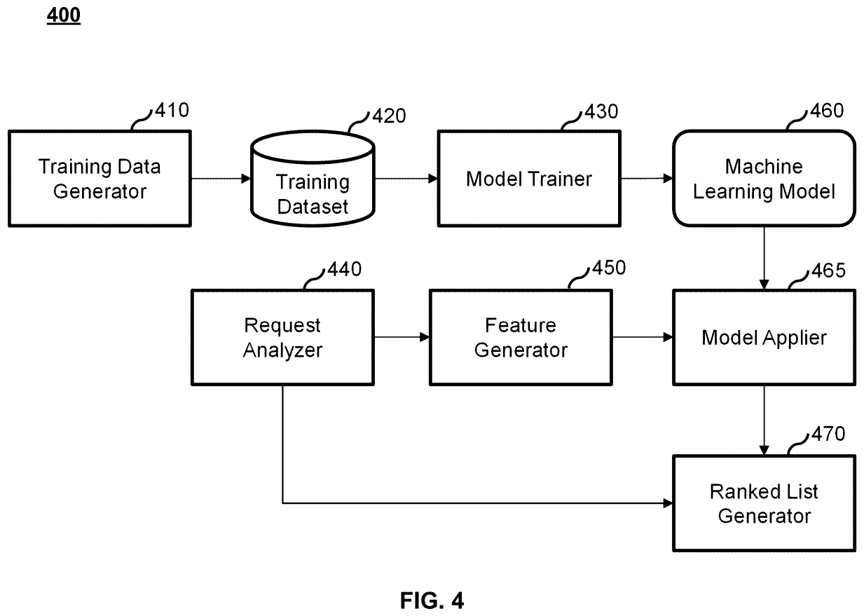

FIG. 4 illustrates an example architecture of a system for ranking offers using machine learning, in accordance with some embodiments. In some embodiments, the system 400 can be implemented by one or more computing devices, such as the ranked offer computing device 102 and/or the cloud-based engine 121 of FIG. 1.

As shown in FIG. 4, the system 400 in this example includes a training data generator 410, a model trainer 430, a request analyzer 440, a feature generator 450, a model applier 465 and a ranked list generator 470. In some embodiments, the training data generator 410 and the model trainer 430 may be configured to train a machine learning model 460 during a training stage of the machine learning model 460. The request analyzer 440, the feature generator 450, the model applier 465 and the ranked list generator 470 may be configured to utilize the machine learning model 460 to generate a ranked offer list for offers associated with a given item, during an inference stage of the machine learning model 460.

In some examples, the training data generator 410 may determine a default offer for each of a plurality of items. The plurality of items may be offered for sale by a retailer or have been offered for sale previously. The training data generator 410 can generate label data based on orders placed regarding the default offers for the plurality of items. In some examples, each offer may be labelled as order or no-order based on a binary classification for each impression (e.g. when the offer is presented to a user). In some examples, an order conversion rate of an item can be computed regarding its default offer displayed via item pages or other web pages. The training data generator 410 may also generate the order conversion rate for each default offer as part of the label data.

In some examples, the training data generator 410 may also generate feature data of the default offers for the plurality of items. For example, the training data generator 410 may generate absolute price and shipping features of a default offer, as well as differential price and shipping features between the default offer and other offers. In some embodiments, the feature data may comprise at least: a minimum total price that is a lowest price among all total prices of offers to be ranked; a minimum shipping time that is a shortest shipping time among all shipping times of the offers to be ranked; a total price difference between a total price of each offer and the minimum total price; and a shipping time difference between a shipping time of each offer and the minimum shipping time. The total price difference and the shipping time difference can be used as contextual features representing how competitive an offer is compared to the best (cheapest or fastest) offer among the offers to rank. In some examples, a total price may be equal to: an offer item price plus a shipping cost minus a discount. In some examples, the minimum total price and the total price difference are rounded to whole dollars during a training stage to avoid noisy results.

Based on both the feature data and the label data, the training data generator 410 may generate a training dataset 420, which may be part of the database 116 or a standalone database. In some examples, the training dataset 420 may be generated based on winning and non-winning offers. In some examples, the training dataset 420 may be generated based on winning offers only since the non-winning offers have very low impressions. In some examples, the training dataset 420 may be generated based on offers displayed on various types of webpages. In some examples, the training dataset 420 may be generated based on offers displayed on item pages, but not search or browse pages due to position bias regarding conversion rates on those webpages.

In some embodiments, the model trainer 430 can train the machine learning model 460 using the training dataset 420 during a training stage. In some examples, using the feature data in the training dataset 420 as model inputs, the machine learning model 460 may be trained to output order conversion scores that optimize an objective function subject to a monotonic constraint. For example, the objective function may be a point-wise loss for predicting a conversion probability of each individual offer. In some examples, the objective function may be formed by a difference between the order conversion scores output by the machine learning model 460 and labelled order conversion rates in the training dataset 420. By optimizing or minimizing the objective function, the machine learning model 460 can be trained to learn how to transfer offer features of each individual offer to its predicted probability of offer conversion. In some examples, the feature data and the training dataset 420 do not include a raw price or a raw shipping speed for any item to train the machine learning model 460.

In some examples, the monotonic constraint requires a monotonic relationship from each feature in the feature data to the output order conversion scores, given other features in the feature data. That is, if one feature is changed while keeping all other features unchanged, the output order conversion score will always change monotonically according to the change of the feature. The monotonic constraint may be either an increasing constraint or a decreasing constraint. For an increasing constraint enforced on feature X, for example, increasing feature X while keeping all other features unchanged, will always cause the output order conversion score to increase or at least not decrease. For a decreasing constraint enforced on feature Y, for example, increasing feature Y while keeping all other features unchanged, will always cause the output order conversion score to decrease or at least not increase.

In some examples, the machine learning model 460 can be trained to enforce monotonic constraints on features including: the difference between a total price of each offer and the minimum total price; and the difference between an estimated or promised shipping time of each offer and the minimum shipping time. Accordingly, when for example offers A and B have the same total price but offer A ships slower, then offer A will not have a better order conversion score and will not be ranked higher than offer B, using the machine learning model 460 trained subject to the monotonic constraints. In some examples, when offers C and D have the same shipping speed but offer C has a higher total price, then offer C will not have a better order conversion score and will not be ranked higher than offer D, using the machine learning model 460 trained subject to the monotonic constraints. The machine learning model 460 may be trained to ensure that a more expensive and slower offer will not win compared to a cheaper and faster offer, providing more intuitive ranking results to users.

In some examples, the machine learning model 460 may be an ensemble learning-based model, e.g. a gradient boosted decision trees model, which is a complex amalgamation of different machine learning models. Compared to some rule-based method, the system 400 using the machine learning model 460 may identify winning offers with a lot faster shipping for a little higher price, by learning an intricate tradeoff between price and shipping. This can reduce the chances of sellers manipulating the system, and increase a seller's motivation to improve service quality in terms of price and shipping.

In some embodiments, during an inference stage of the machine learning model 460, the request analyzer 440 may receive a request for ranking a plurality of offers associated with an item. The request analyzer 440 can analyze the request to identify the plurality of offers and their associated sellers, to generate analyzed request data. The request analyzer 440 may send the analyzed request data to the feature generator 450 for feature generation. In some examples, the request analyzer 440 may also send the analyzed request data to the ranked list generator 470 for generating a ranked list of offers.

In some examples, the feature generator 450 may generate offer related feature data for the plurality of offers based on the request analyzed by the request analyzer 440. In some examples, the offer related feature data may comprise: a minimum total price that is a lowest price among all total prices of the plurality of offers; a minimum shipping time that is a shortest shipping time among all shipping times of the plurality of offers; a difference between a total price of each offer and the minimum total price; and a difference between a shipping time of each offer and the minimum shipping time.

In some examples, the model applier 465 may input the offer related feature data generated by the feature generator 450 into the machine learning model 460 to generate an order conversion score for each of the plurality of offers. For example, the order conversion score for an offer may indicate a probability of converting the offer to a purchase order.

In some examples, the ranked list generator 470 may generate, from the plurality of offers, a ranked list of offers based on their respective order conversion scores generated by the model applier 465. The ranked list generator 470 may transmit the ranked list of offers to a computing device for associating the ranked list of offers with the item during a presentation of the item via a user interface or webpage. For example, a top ranked offer from the ranked list of offers may be selected as a default offer to be displayed together with the item in a web page. The web page may be one of: a home page; an item page; a search page; a browse page; or a webpage including a list of personalized carousels, a list of user selected items, a list of user related items, or a list of sponsored advertisements. In some examples, upon a first selection of a user on the web page, the default offer for the item is added into a shopping cart for the user. In some examples, upon a second selection of the user on the web page, the user is re-directed to an additional web page where all offers in the ranked list are displayed in a ranked order.

In some examples, the ranked list generator 470 may generate the ranked list of offers based on filtering the plurality of offers to remove ineligible offers and generate a list of eligible offers. Each ineligible offer may correspond to an out-of-stock status of the item or a violation of a rule associated with the item. The ranked list generator 470 may rank merely the list of eligible offers according to their respective order conversion scores to generate the ranked list of offers.

In some examples, the list of eligible offers may be generated by the request analyzer 440 and sent to the ranked list generator 470. In some examples, the request analyzer 440 may perform a first round of filtering (e.g. to remove out-of-stock offers) to generate a first list of eligible offers and send the first list to the ranked list generator 470; and the ranked list generator 470 can perform a second round of filtering (e.g. to remove additional rule violating offers) on the first list to generate a second list of eligible offers and generate the ranked list based on the second list.

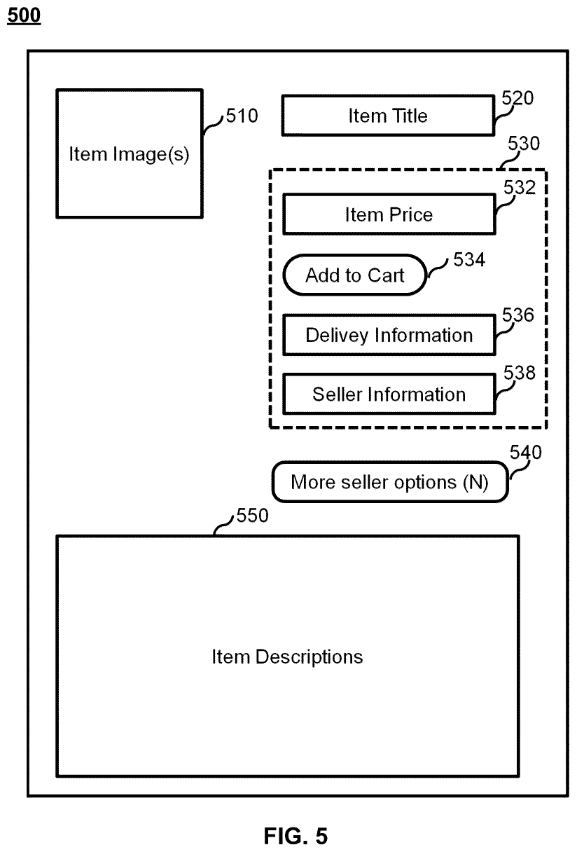

FIG. 5 illustrates an example web page 500 including a default offer for an item, in accordance with some embodiments. In some embodiments, the web page 500 may be an item page showing detailed descriptions of the item.

As shown in FIG. 5, the web page 500 includes: an item image section 510, an item title 520, a default offer section 530, a “more seller options” button 540 and an item description section 550. The item image section 510 may show one or more item images of the item. The item title 520 may be a full title or short title for the item. The item description section 550 may show a detailed description of various features about the item.

In some embodiments, the web page 500 may include additional components not shown in FIG. 5. In some embodiments, the components in the web page 500 may be arranged in different layouts than what is shown in FIG. 5. In some embodiments, the web page 500 may be any webpage including: a home page, an item page, a search page, a browse page, a list of personalized carousels, a list of user selected items, a list of user related items, or a list of sponsored advertisements.

In some examples, the default offer section 530 may also be called a buy box section, and can include various information about a default offer for the item. The default offer may be determined or selected as a top ranked offer from a ranked list of offers for the item, where the ranked list may be generated based on operations in an inference stage of the machine learning model 460 in FIG. 4.

As shown in FIG. 5, the default offer section 530 can include: an item price 532 of the default offer for the item, an “add to cart” button 534, delivery information 536 showing shipping and delivery options of the default offer for the item, and seller information 538 showing information about the seller giving the default offer. In some embodiments, depending on a type of the web page 500 (e.g. an item page, a search result page, a shopping cart page, etc.), the default offer section 530 may include more or less components than what are shown in FIG. 5, and may be located at different locations of the web page 500 than where is located in FIG. 5.

In some examples, when a user clicks on the “add to cart” button 534, the default offer for the item can be automatically added into a shopping cart for the user. In some examples, when a user clicks on the “more seller options” button 540, the user is re-directed to an additional web page where all offers in the ranked list for the item are displayed in a ranked order. In some examples, as shown in FIG. 5, the “more seller options” button 540 also shows a number N representing how many more seller options or offer options are available other than the default offer.

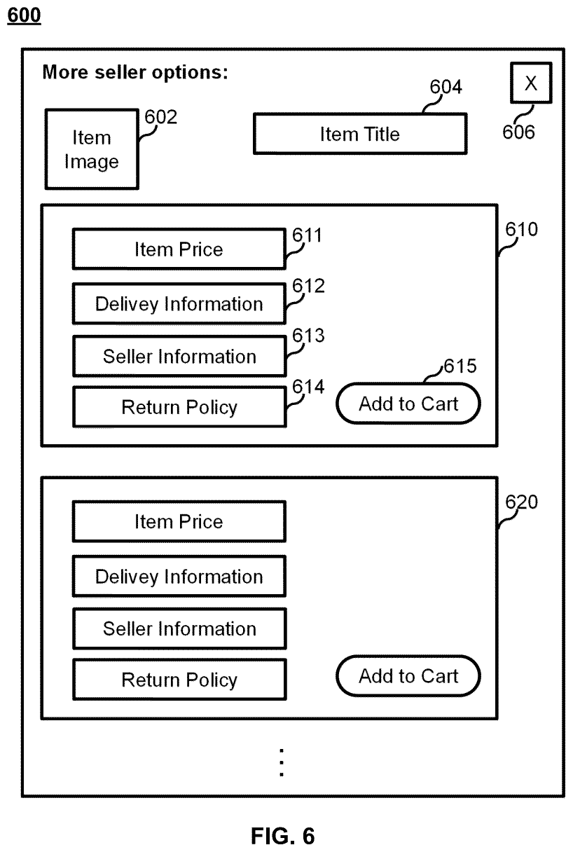

FIG. 6 illustrates an example web page 600 including a ranked list of offers for an item, in accordance with some embodiments. In some embodiments, the web page 600 may be shown to a user, after the user selects a “more seller options” button, e.g. the “more seller options” button 540 in FIG. 5. In some embodiments, the web page 600 may be shown at least partially on top of the web page 500 to the user.

As shown in FIG. 6, the web page 600 includes: an item image 602, an item title 604, and a plurality of offer sections 610, 620. The item image 602 may be one representative image of the item. The item title 604 may be a short title of the item. The web page 600 may include a close button 606, which a user can click on to close the web page 600. In some embodiments, once the user closes the web page 600, the user is automatically re-directed to the original web page (e.g. the web page 500) from where the user is directed to the web page 600.

As shown in FIG. 6, each of the plurality of offer sections 610, 620 may include various information of a corresponding offer for the item. For example, the offer section 610 includes information of a first offer for the item; and the offer section 620 includes information of a second offer for the item. The offer section 610 for example may include: an item price 611 (e.g. a total price after incorporating shipping cost and any discount) of the first offer, a delivery information 612 (e.g. estimated or promised shipping time) of the first offer, a seller information 613 of a first seller giving the first offer, a return policy 614 associated with the first offer, and an “add to cart” button 615. If a user clicks on the “add to cart” button 615 within the offer section 610, the first offer is added to a shopping cart for the user.

In some examples, the first offer is the winning offer among all offers ranked for the item, and the second offer is the second best offer among all offers ranked for the item. That is, the ranked list of offers for the item is shown from top down on the web page 600.

In some embodiments, the web page 600 may first show a portion (including top ranked offers) of the ranked list to a user. The user can scroll down the web page 600 to view additional offers. The system can use a threshold to determine the portion of the ranked list being shown at first. The threshold may be determined based on a distribution of the ranking scores (e.g. order conversion scores) generated for the offers in the ranked list.

In some embodiments, for different users, the offers for the item may be ranked in different orders. For example, user A may have a different location than user B, which may cause a different shipping speed for one or more offers to be ranked regarding the same item.

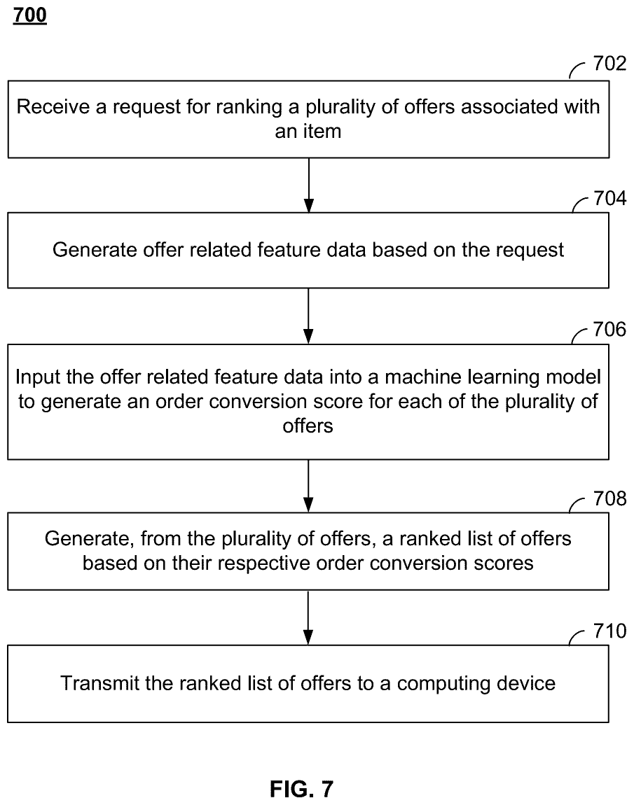

FIG. 7 shows a flowchart illustrating an example method 700 for ranking offers using machine learning, in accordance with some embodiments. In some embodiments, the method 700 can be carried out by a system including one or more computing devices, such as the ranked offer computing device 102 and/or the cloud-based engine 121 of FIG. 1. Beginning at operation 702, a request is received for ranking a plurality of offers associated with an item. At operation 704, offer related feature data may be generated based on the request. At operation 706, the offer related feature data can be input into a machine learning model to generate an order conversion score for each of the plurality of offers. At operation 708, from the plurality of offers, a ranked list of offers is generated based on their respective order conversion scores At operation 710, the ranked list of offers is transmitted to a computing device.

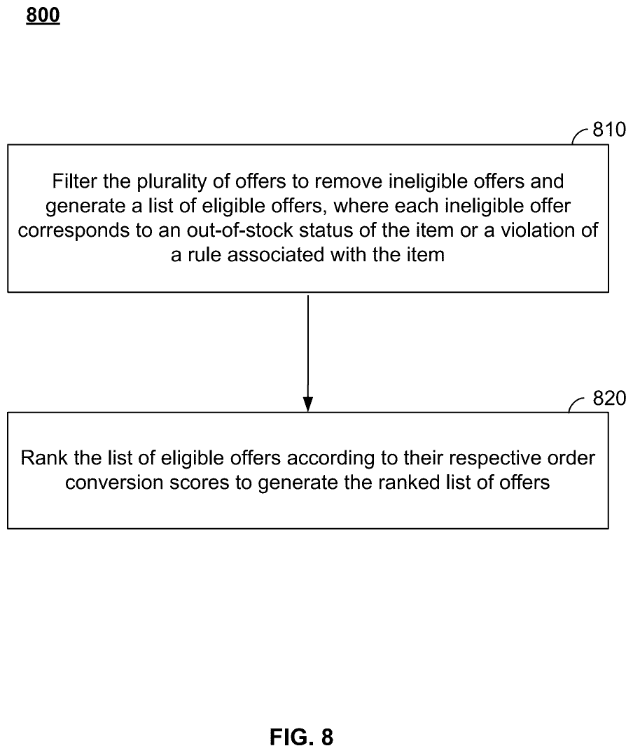

FIG. 8 shows a flowchart illustrating an example method 800 for ranking eligible offers to generate a ranked list, in accordance with some embodiments. In some embodiments, the method 800 can be carried out by a system including one or more computing devices, such as the ranked offer computing device 102 and/or the cloud-based engine 121 of FIG. 1. In some embodiments, the method 800 can be performed as part of the operation 708 of the example method 700 in FIG. 7. Beginning at operation 810, the plurality of offers are filtered to remove ineligible offers and generate a list of eligible offers. Each ineligible offer may correspond to an out-of-stock status of the item or a violation of a rule associated with the item. At operation 820, the list of eligible offers are ranked according to their respective order conversion scores to generate the ranked list of offers.

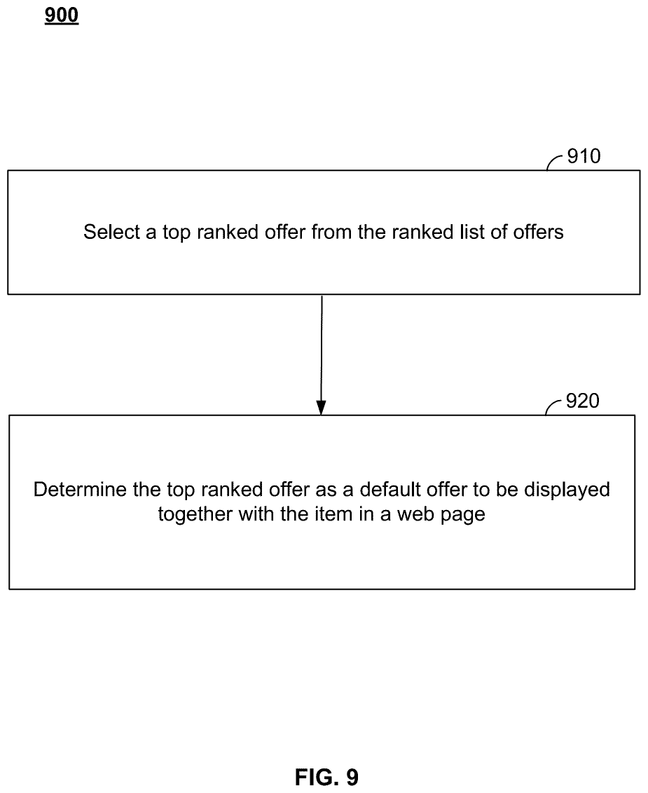

FIG. 9 shows a flowchart illustrating an example method 900 for determining a default offer, in accordance with some embodiments. In some embodiments, the method 900 can be carried out by a system including one or more computing devices, such as the ranked offer computing device 102, the server 104 and/or the cloud-based engine 121 of FIG. 1. Beginning at operation 910, a top ranked offer is selected from the ranked list of offers. At operation 920, the top ranked offer is determined as a default offer to be displayed together with the item in a web page.

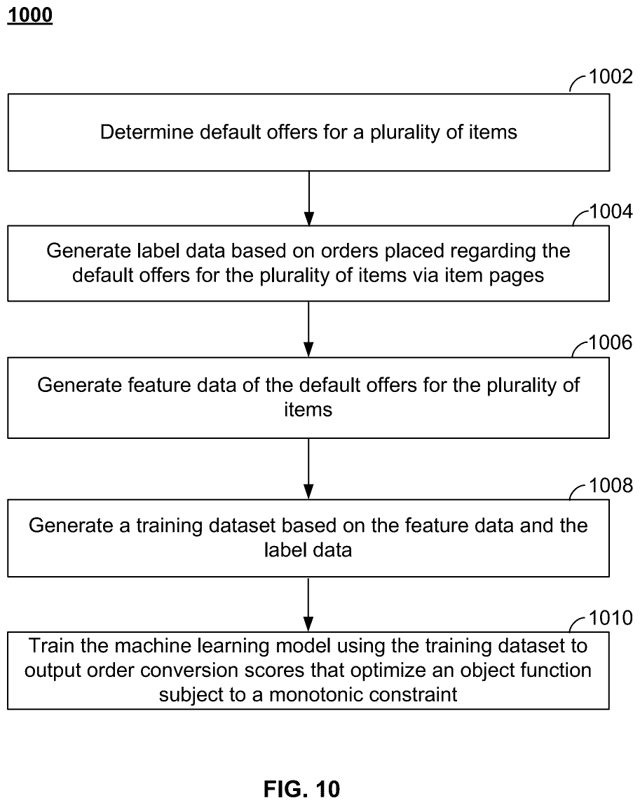

FIG. 10 shows a flowchart illustrating an example method 1000 for training a machine learning model for ranking offers, in accordance with some embodiments. In some embodiments, the method 1000 can be carried out by a system including one or more computing devices, such as the ranked offer computing device 102 and/or the cloud-based engine 121 of FIG. 1. Beginning at operation 1002, default offers are determined for a plurality of items. At operation 1004, label data may be generated based on orders placed regarding the default offers for the plurality of items via item pages. At operation 1006, feature data of the default offers may be generated for the plurality of items. At operation 1008, a training dataset is generated based on the feature data and the label data. At operation 1010, a machine learning model is trained using the training dataset to output order conversion scores that optimize an object function subject to a monotonic constraint.

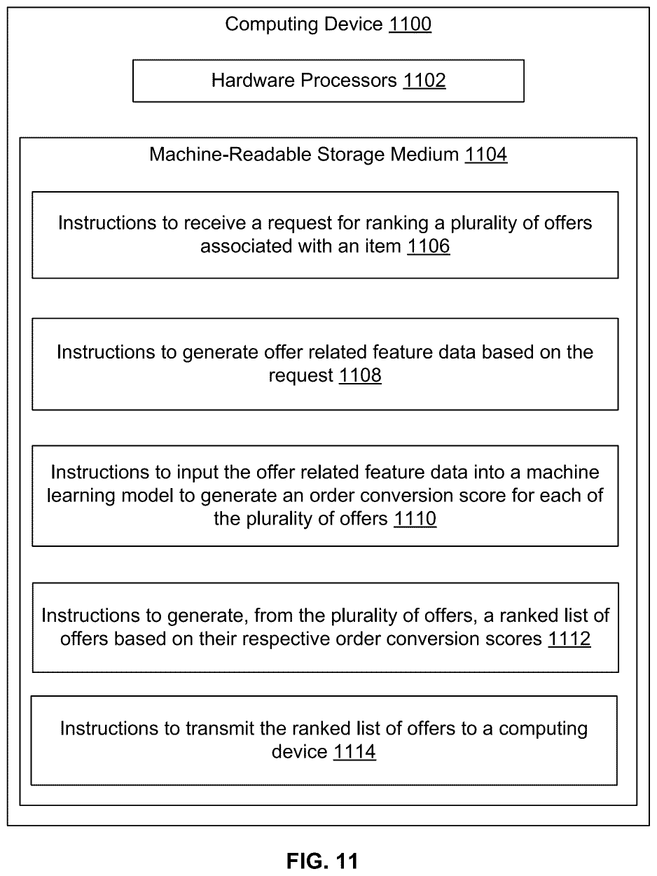

FIG. 11 depicts an example system 1100 (e.g. a computing device) for ranking offers using machine learning, including a machine-readable medium 1104 encoded with example instructions executable by processing resource 1102, e.g. hardware processors, in accordance with some embodiments. In some implementations, the system 1100 may be useful for implementing aspects of the system 400 of FIG. 4. In some implementations, functionality described with respect to FIG. 4 may be included in the instructions encoded on machine-readable medium 1104.

The processing resource 1102 may include a microcontroller, a microprocessor, central processing unit core(s), an ASIC, an FPGA, and/or other hardware device suitable for retrieval and/or execution of instructions from the machine-readable medium 1104 to perform functions related to various examples. Additionally or alternatively, the processing resource 1102 may include or be coupled to electronic circuitry or dedicated logic for performing some or all of the functionality of the instructions described herein.

The machine-readable medium 1104 may be any medium suitable for storing executable instructions, such as RAM, ROM, EEPROM, flash memory, a hard disk drive, an optical disc, or the like. In some example implementations, the machine-readable medium 1104 may be a tangible, non-transitory medium. The machine-readable medium 1104 may be disposed within the system 1100 in which case the executable instructions may be deemed installed or embedded on the system. Alternatively, the machine-readable medium 1104 may be a portable (e.g., external) storage medium, and may be part of an installation package.

As described further herein below, the machine-readable medium 1104 may be encoded with a set of executable instructions. It should be understood that part or all of the executable instructions and/or electronic circuits included within one box may, in alternate implementations, be included in a different box shown in the figures or in a different box not shown. Some implementations may include more or fewer instructions than are shown in FIG. 11.

The machine-readable medium 1104 includes instructions 1106-1114. Instructions 1106, when executed, cause the processing resource 1102 to receive a request for ranking a plurality of offers associated with an item. The instructions 1108, when executed, cause the processing resource 1102 to generate offer related feature data based on the request.

Instructions 1110, when executed, cause the processing resource 1102 to input the offer related feature data into a machine learning model to generate an order conversion score for each of the plurality of offers. The instructions 1112, when executed, cause the processing resource 1102 to generate, from the plurality of offers, a ranked list of offers based on their respective order conversion scores. The instructions 1114, when executed, cause the processing resource 1102 to transmit the ranked list of offers to a computing device.

Although the methods described above are with reference to the illustrated flowcharts, it will be appreciated that many other ways of performing the acts associated with the methods can be used. For example, the order of some operations may be changed, and some of the operations described may be optional.

The methods and system described herein can be at least partially embodied in the form of computer-implemented processes and apparatus for practicing those processes. The disclosed methods may also be at least partially embodied in the form of tangible, non-transitory machine-readable storage media encoded with computer program code. For example, the steps of the methods can be embodied in hardware, in executable instructions executed by a processor (e.g., software), or a combination of the two. The media may include, for example, RAMs, ROMs, CD-ROMs, DVD-ROMs, BD-ROMs, hard disk drives, flash memories, or any other non-transitory machine-readable storage medium. When the computer program code is loaded into and executed by a computer, the computer becomes an apparatus for practicing the method. The methods may also be at least partially embodied in the form of a computer into which computer program code is loaded or executed, such that, the computer becomes a special purpose computer for practicing the methods. When implemented on a general-purpose processor, the computer program code segments configure the processor to create specific logic circuits. The methods may alternatively be at least partially embodied in application specific integrated circuits for performing the methods.

Each functional component described herein can be implemented in computer hardware, in program code, and/or in one or more computing systems executing such program code as is known in the art. As discussed above with respect to FIG. 2, such a computing system can include one or more processing units which execute processor-executable program code stored in a memory system. Similarly, each of the disclosed methods and other processes described herein can be executed using any suitable combination of hardware and software. Software program code embodying these processes can be stored by any non-transitory tangible medium, as discussed above with respect to FIG. 2.

The foregoing is provided for purposes of illustrating, explaining, and describing embodiments of these disclosures. Modifications and adaptations to these embodiments will be apparent to those skilled in the art and may be made without departing from the scope or spirit of these disclosures. Although the subject matter has been described in terms of example embodiments, it is not limited thereto. Rather, the appended claims should be construed broadly, to include other variants and embodiments, which can be made by those skilled in the art.

What is claimed is:

1. A system, comprising:
a processor; and
a non-transitory memory storing instructions, that when executed, cause the processor to:
receive a request for ranking a plurality of offers associated with an item,
generate offer related feature data based on the request,
input the offer related feature data into a machine learning model to generate an order conversion score for each of the plurality of offers,
generate, from the plurality of offers, a ranked list of offers based on their respective order conversion scores, and
transmit the ranked list of offers to a computing device.

2. The system of claim 1, wherein the offer related feature data comprises at least:
a minimum total price that is a lowest price among all total prices of the plurality of offers;
a minimum shipping time that is a shortest shipping time among all shipping times of the plurality of offers;
a difference between a total price of each offer and the minimum total price; and
a difference between a shipping time of each offer and the minimum shipping time.

3. The system of claim 1, wherein the order conversion score for an offer indicates a probability of converting the offer to a purchase order.

4. The system of claim 1, wherein the ranked list of offers is generated based on:
filtering the plurality of offers to remove ineligible offers and generate a list of eligible offers, wherein each ineligible offer corresponds to an out-of-stock status of the item or a violation of a rule associated with the item; and
ranking the list of eligible offers according to their respective order conversion scores to generate the ranked list of offers.

5. The system of claim 1, wherein the instructions, when executed, further cause the processor to:
select a top ranked offer from the ranked list of offers; and
determine the top ranked offer as a default offer to be displayed together with the item in a web page.

6. The system of claim 5, wherein:
the web page comprises at least one of: a home page, an item page, a search page, a browse page, a list of personalized carousels, a list of user selected items, a list of user related items, or a list of sponsored advertisements;
upon a first selection of a user on the web page, the default offer for the item is added into a shopping cart for the user; and
upon a second selection of the user on the web page, the user is re-directed to an additional web page where all offers in the ranked list are displayed in a ranked order.

7. The system of claim 1, wherein the machine learning model is trained based on:
determining default offers for a plurality of items;
generating label data based on orders placed regarding the default offers for the plurality of items via item pages;
generating feature data of the default offers for the plurality of items;
generating a training dataset based on the feature data and the label data; and
training the machine learning model using the training dataset to output order conversion scores that optimize an objective function subject to a monotonic constraint.

8. The system of claim 7, wherein:
the objective function is a point-wise loss for predicting a conversion probability of each individual offer; and
the monotonic constraint requires a monotonic relationship from each feature in the feature data to the output order conversion scores, given other features in the feature data.

9. A computer-implemented method, comprising:
receiving a request for ranking a plurality of offers associated with an item;
generating offer related feature data based on the request;
inputting the offer related feature data into a machine learning model to generate an order conversion score for each of the plurality of offers;
generating, from the plurality of offers, a ranked list of offers based on their respective order conversion scores; and
transmitting the ranked list of offers to a computing device.

10. The computer-implemented method of claim 9, wherein the offer related feature data comprises at least:
a minimum total price that is a lowest price among all total prices of the plurality of offers;
a minimum shipping time that is a shortest shipping time among all shipping times of the plurality of offers;
a difference between a total price of each offer and the minimum total price; and
a difference between a shipping time of each offer and the minimum shipping time.

11. The computer-implemented method of claim 9, wherein the order conversion score for an offer indicates a probability of converting the offer to a purchase order.

12. The computer-implemented method of claim 9, wherein generating the ranked list of offers comprises:
filtering the plurality of offers to remove ineligible offers and generate a list of eligible offers, wherein each ineligible offer corresponds to an out-of-stock status of the item or a violation of a rule associated with the item; and
ranking the list of eligible offers according to their respective order conversion scores to generate the ranked list of offers.

13. The computer-implemented method of claim 9, further comprising:
selecting a top ranked offer from the ranked list of offers; and
determining the top ranked offer as a default offer to be displayed together with the item in a web page.

14. The computer-implemented method of claim 13, wherein:
the web page comprises at least one of: a home page, an item page, a search page, a browse page, a list of personalized carousels, a list of user selected items, a list of user related items, or a list of sponsored advertisements;
upon a first selection of a user on the web page, the default offer for the item is added into a shopping cart for the user; and
upon a second selection of the user on the web page, the user is re-directed to an additional web page where all offers in the ranked list are displayed in a ranked order.

15. The computer-implemented method of claim 9, wherein the machine learning model is trained based on:
determining default offers for a plurality of items;
generating label data based on orders placed regarding the default offers for the plurality of items via item pages;
generating feature data of the default offers for the plurality of items;
generating a training dataset based on the feature data and the label data; and
training the machine learning model using the training dataset to output order conversion scores that optimize an objective function subject to a monotonic constraint.

16. The computer-implemented method of claim 15, wherein:
the objective function is a point-wise loss for predicting a conversion probability of each individual offer; and
the monotonic constraint requires a monotonic relationship from each feature in the feature data to the output order conversion scores, given other features in the feature data.

17. A non-transitory computer readable medium having instructions stored thereon, wherein the instructions, when executed by at least one processor, cause at least one device to perform operations comprising:
receiving a request for ranking a plurality of offers associated with an item;
generating offer related feature data based on the request;
inputting the offer related feature data into a machine learning model to generate an order conversion score for each of the plurality of offers;
generating, from the plurality of offers, a ranked list of offers based on their respective order conversion scores; and
transmitting the ranked list of offers to a computing device.

18. The non-transitory computer readable medium of claim 17, wherein the offer related feature data comprises at least:
a minimum total price that is a lowest price among all total prices of the plurality of offers;
a minimum shipping time that is a shortest shipping time among all shipping times of the plurality of offers;
a difference between a total price of each offer and the minimum total price; and
a difference between a shipping time of each offer and the minimum shipping time.

19. The non-transitory computer readable medium of claim 17, wherein the machine learning model is trained based on:
determining default offers for a plurality of items;
generating label data based on orders placed regarding the default offers for the plurality of items via item pages;
generating feature data of the default offers for the plurality of items;
generating a training dataset based on the feature data and the label data; and
training the machine learning model using the training dataset to output order conversion scores that optimize an objective function subject to a monotonic constraint.

20. The non-transitory computer readable medium of claim 19, wherein:
the objective function is a point-wise loss for predicting a conversion probability of each individual offer; and
the monotonic constraint requires a monotonic relationship from each feature in the feature data to the output order conversion scores, given other features in the feature data.
